(19) United States
(12) Patent Application Publication
(10) Pub. No.: US 2013/0160240 A1
(43) Pub. Date: Jun. 27, 2013

(54) Damping Assembly and Damping Mechanism Therefor

(71) Applicant: Cavity Sliders Limited, Mount Wellington (NZ)

(72) Inventor: Philip Richard Kenny, Auckland (NZ)

(73) Assignee: CAVITY SLIDERS LIMITED, Mount Wellington (NZ)

(21) Appl. No.: 13/706,810

(22) Filed: Dec. 6, 2012

(30) Foreign Application Priority Data
Dec. 23, 2011 (NZ) 597360

(51) Int. Cl. E05D 15/06; E05D 5/00

(52) U.S. Cl. CPC E05D 15/0626; E05D 15/063; E05D 5/00
USPC 16/89; 16/95 R; 29/407.09

(57) ABSTRACT

A damping assembly for a door, and particularly for use in a pocket door that slides along a track arrangement into an enclosed pocket. The damping assembly catches the door and moves it fully open or fully closed in a gentle manner as it reaches the ends of the track arrangement. The damping assembly can be conveniently removed from the track arrangement for maintenance.

### FIELD OF THE INVENTION

The invention is an improved damped door assembly and damping mechanism therefor. More particularly the invention is a damping mechanism for use in a damped sliding door assembly.

### BACKGROUND TO THE INVENTION

Damped door assemblies are well known. In particular, a damping mechanism is sold commercially by HÄFAELE in the form of their “Soft & Silent” door damping systems. Such damping systems operate to catch a sliding door as it slides open or closed on a carriage moving along and inside a hollow elongate track arrangement, and move the sliding door to an open or closed position in a controlled, slow manner.

A damping mechanism is typically located on the carriage, which includes a damping device (such as a piston movable within a cylinder) and an engaging formation for engagement with a complementary engaging formation located towards an end of the track arrangement as the sliding door moves between an open and a close position. When the engaging formation engages with and is held by the complementary engaging formation, the piston is moved under action of a spring bias in a damped manner to slowly move the door to a fully open or fully closed position, thereby reducing the impact of carriage on the ends of the track arrangement. This is typically called a “soft open” or a “soft close” mechanism or action.

Such systems are typically used for sliding doors where the sliding door runs parallel to and staggered from an opening in a wall. In such configurations, the ends of the elongate track arrangement are conveniently accessible for inserting and removing the carriage for maintenance and repair.

However, a problem exists with such systems in that they are not suited for pocket—type doors, in which a sliding door is opened into a cavity in an adjacent wall, and where the sliding door is typically aligned with the wall in which the door or window opening is located. Such pocket-type sliding doors typically mean that the sliding door in its closed position abuts against an inside surface of a door jamb or opening in a wall, or orthogonal to a wall surface. In such configurations, the ends of the track arrangement are not conveniently accessible to remove the carriage for repair or replacement.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purpose of this specification, where method steps are described in sequence, the sequence does not necessarily mean that the steps are to be chronologically ordered in that sequence, unless there is no other logical manner of interpreting the sequence.

It is an object of the present invention to provide a damped door assembly and a damping mechanism therefor which overcomes or at least partially ameliorates some of the abovementioned disadvantages or which at least provides the public with a useful choice.

### SUMMARY OF THE INVENTION

In one aspect, the invention may be said to broadly consist in a damping assembly, suitable for use with a sliding closure assembly, said damping assembly comprising:

a track arrangement configured and adapted for guiding movement of a carriage along a guide path;

a carriage moveable in a reciprocal manner along the guide path,

a damping mechanism for damping movement of said carriage as it approaches one or either end of the guide path;

wherein the carriage is removable from the track arrangement in a direction transverse to the direction of movement of the carriage on the track arrangement.

Preferably, the track arrangement is hollow.

Alternately, the track arrangement is comprises a recess along its length along which the carriage is moveable.

Preferably, the recess is a slot.

Alternately, the track arrangement comprises a hollow member with a slot in a lower face.

Preferably, the carriage comprises support formations for supporting a sliding closure.

Preferably, the damping assembly comprises a sliding closure.

Preferably, the sliding closure is movable between an open position and a closed position on the carriage.

Preferably, the open position and a closed position corresponds to the sliding closure being in an open position and a closed position respectively.

Preferably, the carriage is configured for supporting a sliding closure through said slot.

Preferably, the damping mechanism is located on the carriage.

Preferably, the carriage comprises a body member and an associated running arrangement.

Preferably, the body member and damping mechanism are together configured and adapted to be removed through the slot.

Preferably, the body member is elongate.

Preferably, the track arrangement extends into a recessed cavity.

Preferably, the width of the body member is thinner than the width of the slot.

Preferably, the track arrangement comprises a widened portion.

Preferably, the running arrangements are removable from within the track arrangement via the widened portion.

Preferably, the running arrangements and body member are removably coupled to each other.

Preferably, the running arrangement and body member may be conveniently decoupled from each other.

Preferably, the running arrangement comprises one or more wheels.

Preferably, the running arrangement comprises one or more sets of wheels.

Preferably, the one or more sets of wheels are located at opposed ends of the carriage.

Preferably, the damping mechanism comprises an engaging formation on one or more of the carriage and the track arrangement, for engaging with complementary engaging formations located on the other of the carriage and the track arrangement.

Preferably, the damping mechanism comprises a piston reciprocally movable within damping cylinder for damping movement of the carriage when the engaging formation encounters the complementary engaging formation, to thereby move the sliding door to one or more selected from its fully open position and fully closed position.

Preferably, damping fluid is container within the damping cylinder, which moves between a pair of enclosures through a damping valve when the piston moves within the cylinder.

Preferably, the damping mechanism is located on the body member.

Preferably, the damping mechanism is movable between a compressed condition and an uncompressed condition.

Preferably, the damping mechanism is biased towards one selected from its compressed condition and its uncompressed condition.

Preferably, the damping mechanism comprises a biasing arrangement that is movable between a compressed condition and an uncompressed condition.

Preferably, the compressed condition and an uncompressed condition of the damping mechanism correlate with the compressed condition and an uncompressed condition of the damping mechanism.

Preferably, the biasing arrangement is one or more selected from a
spring; and
compressible fluid.

Preferably, a single engaging formation on the body member is engageable with a plurality of complementary engaging formations associated with the track arrangement.

Preferably, the track arrangement is disposed substantially horizontally.

Alternately, the track arrangement is disposed at an angle so that the weight of at least the sliding door and damping mechanism cause the sliding door to move towards one selected from the open position and the closed position.

Preferably, the engaging formation and complementary engaging formations engage with and hold each other as the carriage approaches an end of its guide path and the sliding closure moves to one selected from its open position and its closed position.

Preferably, the engaging formation and complementary engaging formations engage with and hold each other as the carriage approaches an end of its guide path, and actuates movement of the damping cylinder to move between its compressed condition and is uncompressed condition.

Preferably, the engaging formation and complementary engaging formations engage with and hold each other as the carriage approaches an end of its guide path, and actuates movement of the damping cylinder to move between its compressed condition and is uncompressed condition by virtue of its bias, thereby moving said sliding closure to said one or more selected from its open condition and its closed condition.

Preferably, the carriage comprises a running arrangement at opposed ends of the body member.

Preferably, either or both of the running arrangements are removably connectable to the body member by complementary connecting formations.

Preferably, the complementary connecting formations comprise a spigot and socket arrangement.

Preferably, the sliding closure when moving to its open position, moves into a recessed cavity.

Preferably, the recessed cavity is within a wall.

Preferably, the track arrangement is elongate and extends between two ends.

Preferably, the track arrangement is disposed within a recessed cavity.

Preferably, the engaging formation of the damping mechanism is engageable with complementary engaging formations disposed at or towards each end of the track arrangement.

Preferably, the support formations allow for convenient coupling of the sliding closure to the carriage.

Preferably, the coupling is by means of one or more selected from the following;
screw fitting, or
bayonet fitting, and
snap fitting.

Preferably, the complementary engaging formations for engagement with the engaging formation of the damping mechanism are adjustable for position.

Preferably, the complementary engaging formations for engagement with the engaging formation of the damping mechanism are adjustable for position by a threaded formation.

Preferably, each wheel is associated with an axle.

Preferably, a pair of wheels is associated with an axle.

Preferably, at least one axle is mounted on a set of bearings.

Preferably, at least one axle is mounted on a set of needle roller bearings.

Preferably, each axle is mounted on at least one or more needle roller bearings.

Preferably, the sliding closure is a sliding door.

Preferably, the damping assembly comprises an idler carriage for facilitating the support of the sliding closure.

In another aspect, the invention may be said to broadly consist in a method of removing a carriage including a body disposed intermediate at least two running arrangements on which the body is moveable on a track arrangement, said carriage being movable on a guide path along a track arrangement, said carriage being suitable for supporting a sliding closure from a track arrangement through one selected from a slot and a recess, said slot or recess comprising a widened portion, the body being thinner than said slot or recess, said method comprising the steps of
aligning a first running arrangement with a widened portion of said slot;
moving the first running arrangement through the widened portion; and
moving the body through the slot.

Preferably, the method comprises the steps of
aligning the second running arrangement with the widened portion of the slot; and
moving said other running arrangement through the widened portion to remove the carriage from the track arrangement.

Preferably, the running arrangements are sets of wheel.

Preferably, the body comprises a damping mechanism configured for damping movement of said carriage as it traverses at least one end of the guide path.

In another aspect, the invention may be said to broadly consist in a sliding closure assembly comprising a damping assembly as described above.

In another aspect, the invention may be said to broadly consist in a sliding closure assembly comprising a sliding closure supported from a damping assembly as described above.

In another aspect, the invention may be said to broadly consist in a carriage for use on a track arrangement comprising a hollow member with a slot in it, wherein the carriage is removable from said slot in a direction substantially transversely to the direction of movement of the carriage on the track arrangement.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1: shows a top perspective view of a carriage;

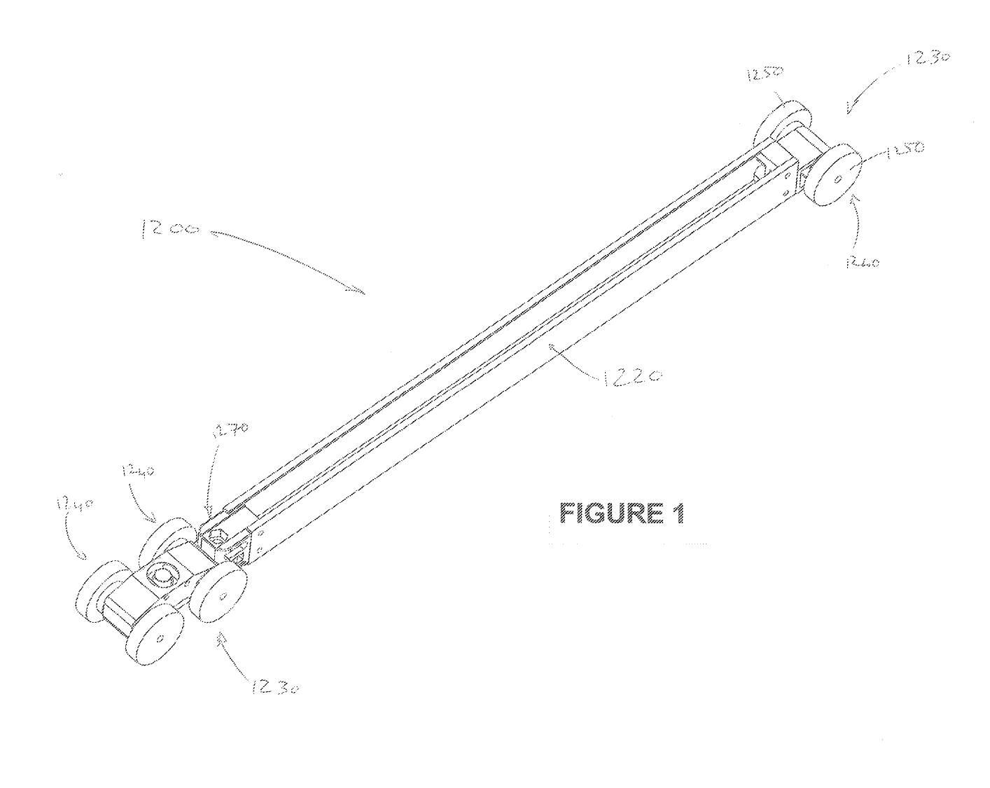

FIG. 2: shows an end view of a damping assembly showing a carriage in a track arrangement;

FIG. 3: shows a first end view of the track arrangement of FIGS. 2, 15, and 16;

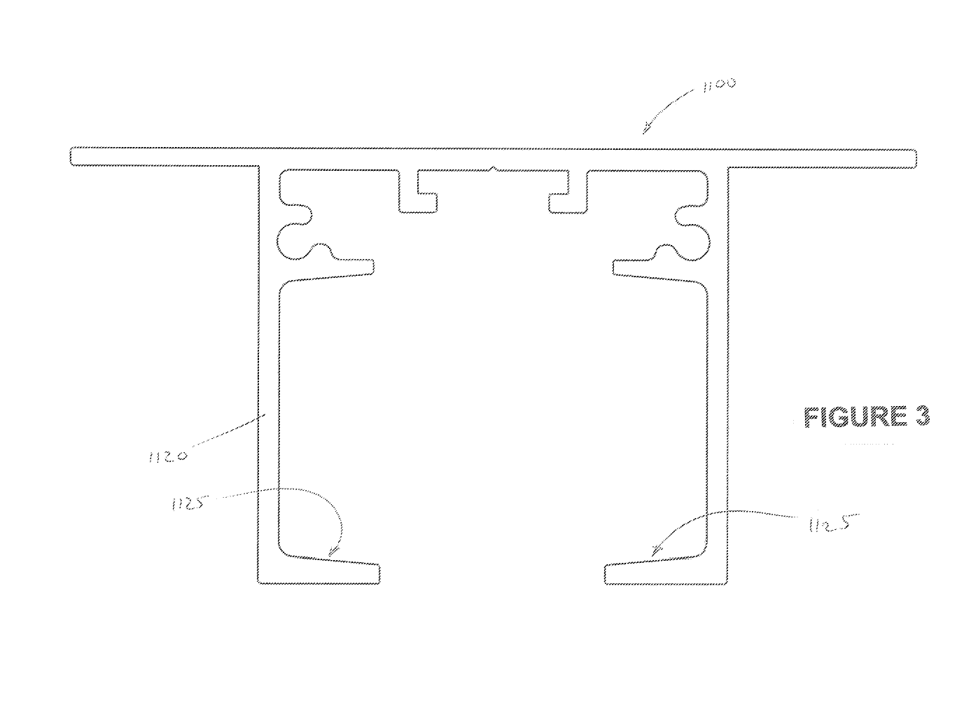

FIG. 4: shows a first top perspective exploded view of the carriage of FIG. 1 as viewed from one side thereof;

FIG. 5: shows a second top perspective exploded view of the carriage shown in FIG. 4 as viewed from another side thereof;

FIG. 6: shows a top perspective exploded view of a first set of wheels for use in the carriage;

FIG. 7: shows a top perspective exploded view of a second set of wheels for use on an opposed side of the carriage from the set of wheels of FIG. 6, including an adjustable support formation for supporting a sliding closure;

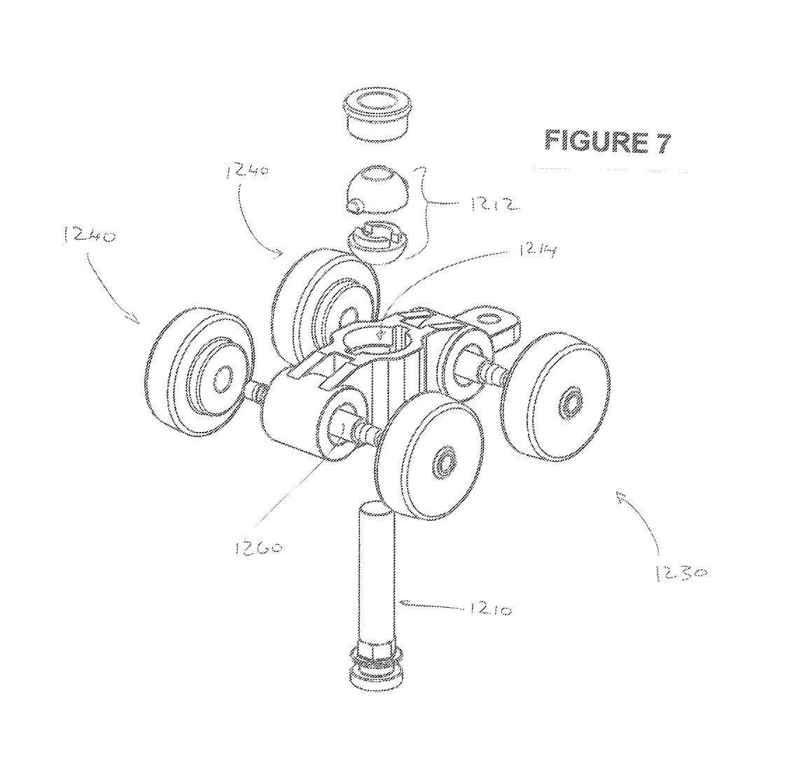

FIG. 8: shows a bottom perspective view of a carriage being removed from the track arrangement;

FIG. 9: shows an elevation schematic view of a sliding closure assembly with a damping assembly for damping movement of the sliding closure to its closed position;

FIG. 10: shows an elevation schematic view of a sliding closure assembly with a damping assembly for damping movement of the sliding closure to its open position;

FIG. 11: shows an elevation schematic view of a sliding closure assembly with a damping assembly for damping movement of the sliding closure to both its open position and its closed position;

FIG. 12: shows a top perspective view of a pocket type door frame with a damping assembly, showing close up details of the ends of the track arrangement;

FIG. 13: shows a bottom perspective view of a pocket type door frame with a damping assembly, showing close up views of the widened portion of the track arrangement;

FIG. 14: shows a perspective view of a pocket type door frame with a damping assembly, showing close up detail of a cutaway section of the track arrangement;

FIG. 15: shows a top perspective view of a track arrangement;

FIG. 16: shows a bottom perspective view of a track arrangement; and

FIG. 17: shows a second end view of the track arrangement of FIGS. 15 and 16.

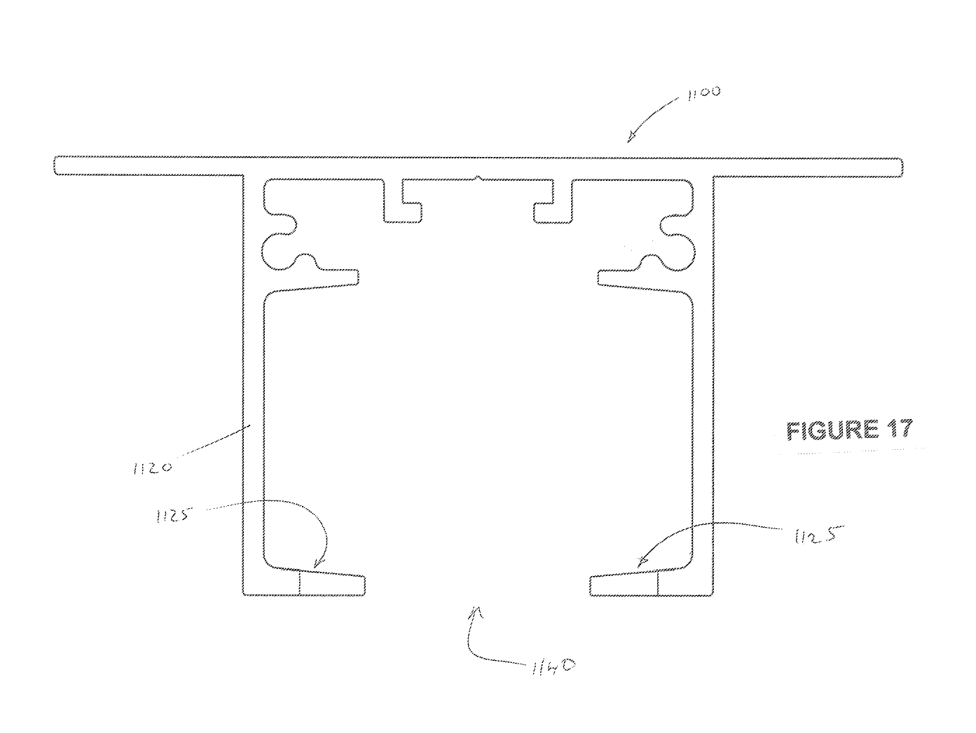

### DETAILED DESCRIPTION OF THE EMBODIMENT(S)

With reference to the above drawings, in which similar features are generally indicated by similar numerals, a damping assembly according to a first aspect of the invention is generally indicated by the numeral 1000, and a sliding closure assembly by the numeral 2000.

In one embodiment now described there is provided a damping assembly 1000. The damping assembly 1000 is suitable for use in a sliding closure assembly 2000. The damping assembly 1000 comprises a track arrangement 1100, a carriage 1200 and a damping arrangement or damping mechanism 1300. The track arrangement 1100 is configured and adapted for guiding movement of the carriage 1200 along a guide path 1110.

In the embodiments shown in the figures, the track arrangement 1100 comprises a hollow member 1120 with a slot 1130 extending along the length of the hollow member 1120. In another embodiment not shown, the track arrangement could comprise a body member that defines a recess into which at least part of the carriage is receivable.

The carriage 1200 is moveable in a reciprocal manner between two ends 1112 of the guide path 1110. The carriage 1200 comprises a body member 1220 and an associated running arrangement 1230.

The running arrangement 1230 comprises a set of wheels 1250 disposed at opposed ends of the elongate body member 1220. The wheels 1250 are configured and dimensioned to run along an inner surface 1125 of the hollow member 1120, which defines the guide path 1110.

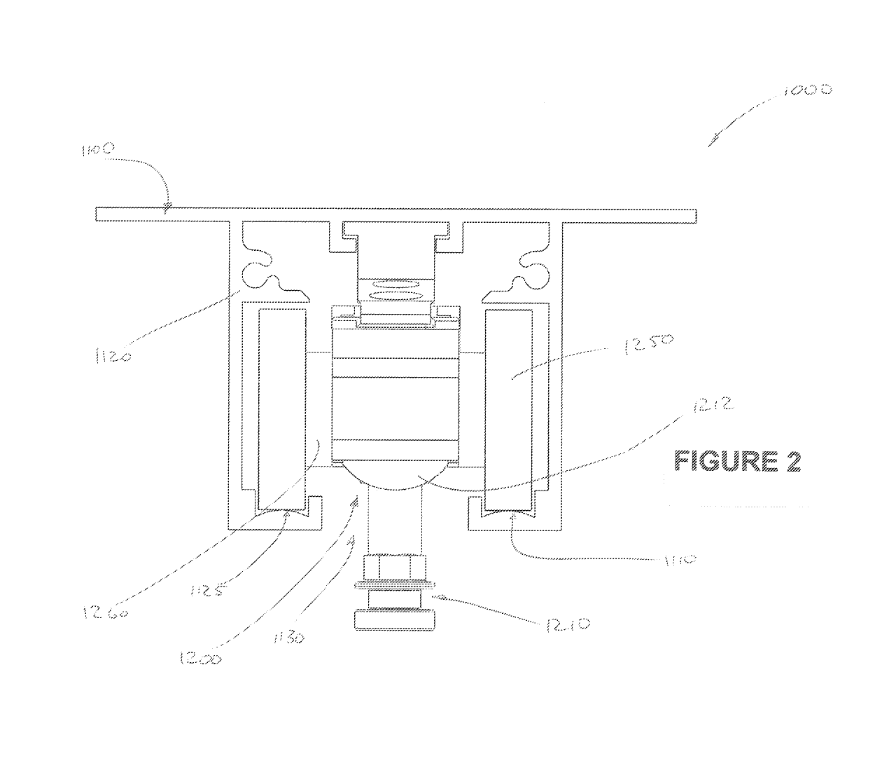

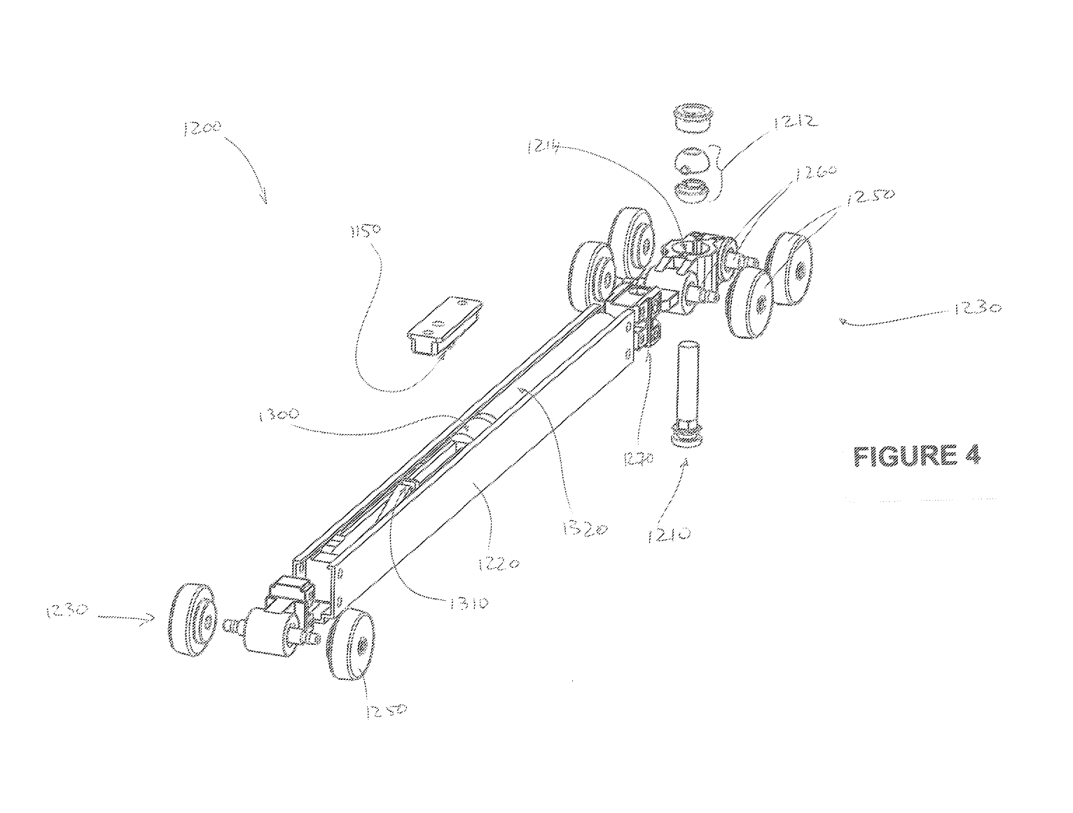

The carriage 1200 is configured for supporting a sliding closure 2100 (i.e. a sliding door or window) through the slot 1130 in the hollow member 1120. In this way, the sliding closure 2100 is moveable between an open position and a closed position supported on the carriage 1200. The carriage 1200 supports the sliding closure 2100 on support formations 1210. It is envisaged that the support formations 1210 will be configured and adapted to allow for a convenient snap fit engagement between the carriage 1200 and the sliding closure 2100. In another embodiment, the support formations 1210 will be configured and adapted to allow for a convenient screw or bayonet fit engagement between the carriage 1200 and the sliding closure 2100, or any other suitable fit. It is further envisaged that in a preferred embodiment, the support formations 1210 will be movable to allow for the hanging of the sliding closure 2100 at a slight angle, for reasons that will be described below. In FIGS. 2 and 4, the support formation 1210 comprise a ball joint 1212 movable within a socket 1214.

The damping assembly further comprises a damping mechanism 1300 for damping movement of the carriage 1200 as it approaches one or both ends of the guide path 1110. In the embodiments shown in the figures, the damping mechanism comprises a piston and cylinder arrangement 1320 comprising a piston (not shown) reciprocally moveable within a cylinder (not shown). The piston is moveable between an extended position and a retracted position within the cylinder. In a preferred embodiment, the piston is biased to its extended position, by a biasing arrangement such as a spring, although it is envisaged that a biasing force could in alternative embodiments also be provided by a compressible fluid that becomes compressed by the piston moving in the cylinder.

As the piston moves within the cylinder, the biasing arrangement moves between a compressed condition in which energy is stored, and an uncompressed condition in which the stored energy is used to drive movement of the piston in the cylinder. The compressed condition of the bias need not necessarily correlate with the retracted condition of the piston, and the uncompressed condition of the bias need not correlate with the extended position of the piston, and may in fact be oppositely correlated.

In a preferred embodiment, the enclosures (not shown) within the cylinder to each side of the piston are filled with a fluid, such as water or oil. The enclosures are in fluid communication with each other, either via an aperture through the piston itself, or via a conduit (not shown). The aperture restricts flow of the fluid, and creates drag on the flow of fluid from one enclosure to another. When the biasing arrangement is moving the piston within the cylinder, this drag will cause the movement of the piston to be slowed.

The damping mechanism 1300 further comprises an engaging formation 1310 associated with the carriage 1200. The engaging formation 1310 is configured for engaging with complementary engaging formations 1150 associated with the track arrangement 1100.

In a preferred embodiment the piston and cylinder are mounted on or within the body member 1220, however this need not be the case. It is envisaged that in other embodiments not shown, the piston and cylinder arrangement 1320, or a plurality of such can be mounted stationary at or towards either end of the track arrangement 1100.

As the sliding closure is 2100 and hence carriage 1200 is moved along the guide path 1110 by a user, for example when opening the sliding closure from a closed position, the engaging formation 1310 associated with the carriage 1200 will engage with and a complementary engaging formation 1150 located along the track arrangement.

As the door is moved further towards its open position, the engaging formation 1310 and complementary engaging formation 1150 engage with and hold each other, moving the piston in the cylinder against the action of the bias, and moving the bias to its compressed condition. When the sliding closure moves past a certain point, a latching mechanism (not shown) is actuated to latch the bias in its compressed condition.

Once the sliding closure is pushed back to its closed position, either by being pushed towards the closed position by a user or under action of gravity, the engaging formation 1310 and complementary engaging formation 1150 engage with and hold each other again, and cause the latching mechanism to be released, and the bias to move slowly to its uncompressed condition against the drag provided by the fluid moving through the aperture.

It is envisaged that the latching mechanism will include a follower formation (not shown) disposed on the free end of the piston, and that is moved along a guiding formation (not shown) by the complementary engaging formation to move it to a latched position as the carriage 1200 moves along track arrangement 1100. As the follower formation follows the guiding formation into a latched configuration, it is moved out of engagement with the complementary engaging formation, thereby latching the bias in its compressed condition.

Piston and cylinder arrangements 1320 as described above, together with its associated engaging formation, complementary engaging formation, and latching mechanism are commercially available, and as one example are manufactured by HÄFAELE™.

Other manufacturers offer similar mechanisms. Further details of the workings of the piston and cylinder arrangement 1320, engaging formation, complementary engaging formation, and latching mechanism and are not considered to be with the scope of this specification and will not be discussed further.

It is envisaged that in one embodiment complementary engaging formations can be located towards either end of the track arrangement, to allow for the unlatching of the spring bias to cause the sliding closure 2100 to move to its closed position or its open position under action of the bias.

When the complementary engaging formation is located at the side of the track that results in the sliding closure being moved and held in its open position, the damping mechanism 1300 will catch a sliding closure that has been slammed open, and ensure that it moves in a damped fashion towards its fully open position. In this configuration, the damping mechanism 1300 serves a dual purpose as a latch to hold the sliding closure in its open position, and to prevent the sliding closure or carriage from slamming against an end of the track arrangement (i.e. as a “soft opening” mechanism).

It is envisaged that in a preferred embodiment, a carriage 1200 with a damping mechanism 1300 will be provided at each end of the top edge of the sliding closure 2100.

However, in alternate embodiments, it is envisaged that other configurations can be presented. For example, in one embodiment not shown, a single piston and cylinder assembly can be configured, for example mounted to the carriage, that operate to damp either the opening or the closing of the sliding closure. It will be appreciated that the sliding closure is freely movable throughout most of its travel, but will only be damped by the damping arrangement as described for the last distance of its travel, either to open or close it fully, or both.

Importantly, the carriage 1300 is removable from the track arrangement 1100 in a direction transverse to the direction of movement of the carriage 1200 on the track arrangement 1100. The reasons for this will be discussed below.

In order to facilitate the removal of the carriage from the track arrangement in such a direction, the body member 1220 and damping mechanism 1300 are together configured and adapted to be removed through the slot 1130.

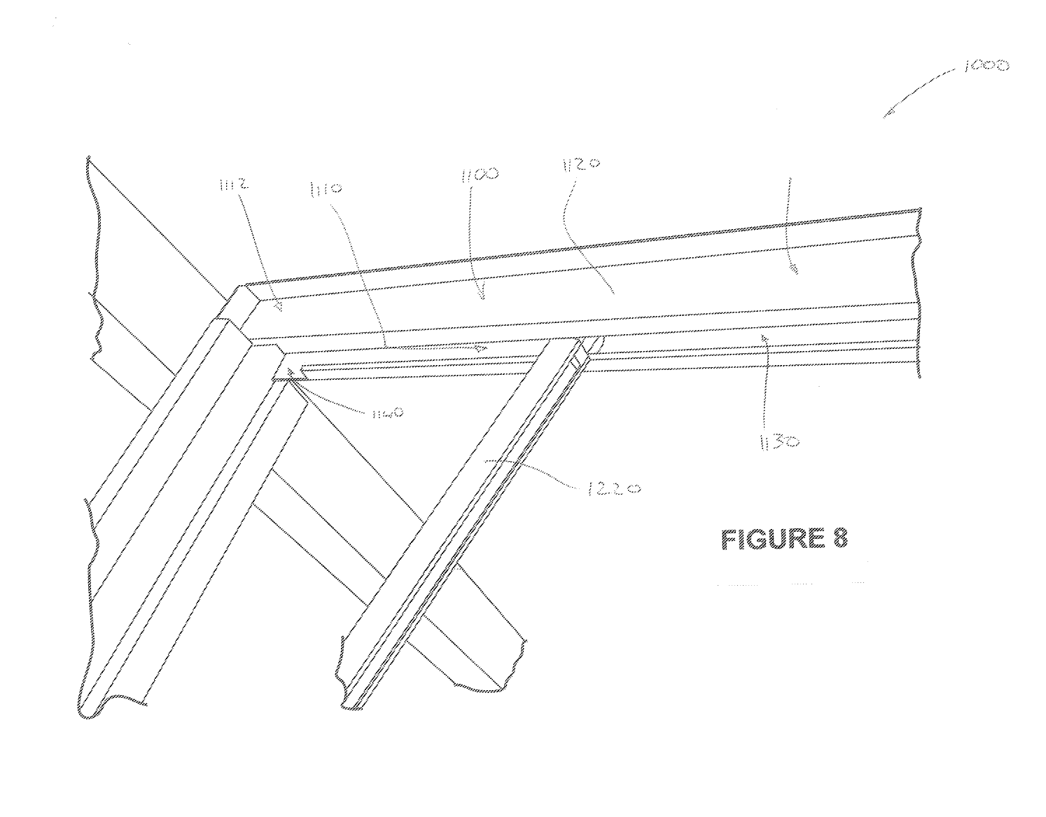

In particular, the width of the body member 1220 (in which is contained the damping mechanism 1300) is envisaged as being thinner than the width of the slot. The application for this is shown in FIG. 8, and the relevance of this will be explained below.

The track arrangement 1100 further comprises a widened portion 1140 of the slot 1130 preferably disposed towards an end of the track arrangement 1100, and more preferably towards an end that is conveniently accessible. It is envisaged that a closure (not shown) may be provided to close the widened portion 1140 of the slot 1130 in one embodiment, or reduce the width of the widened portion to the width of the rest of the slot.

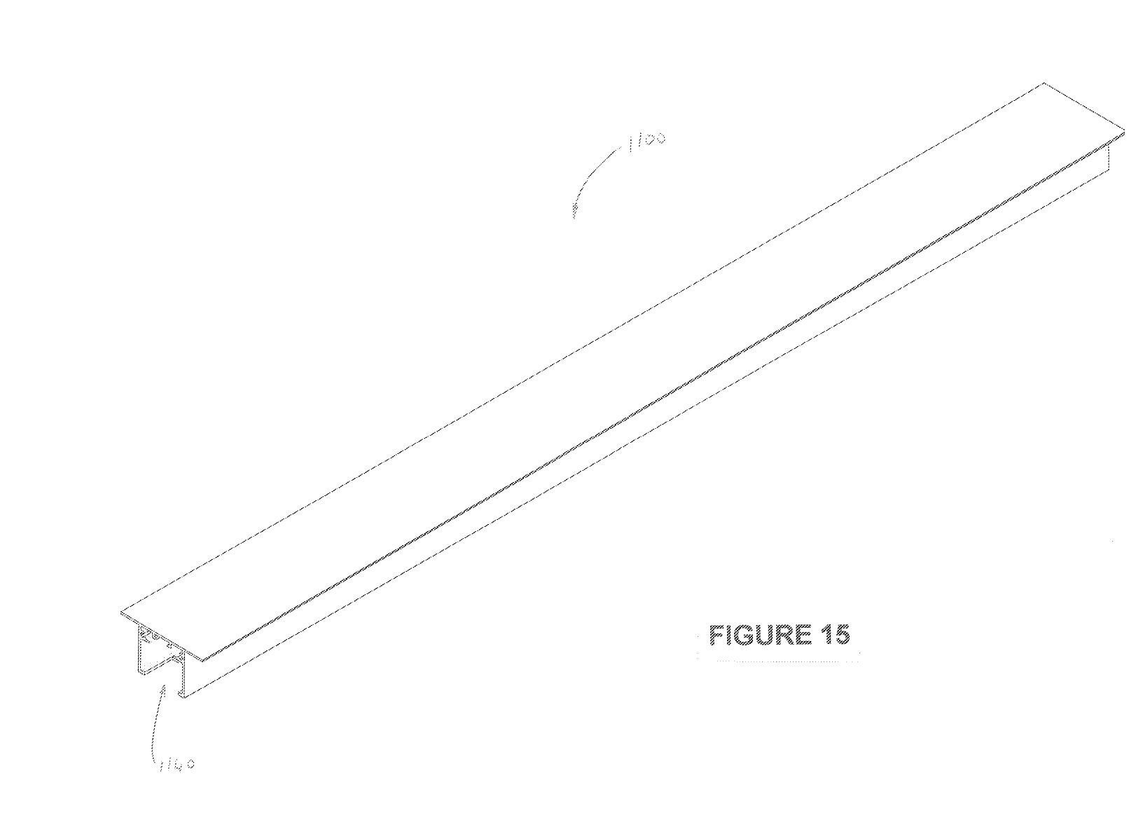

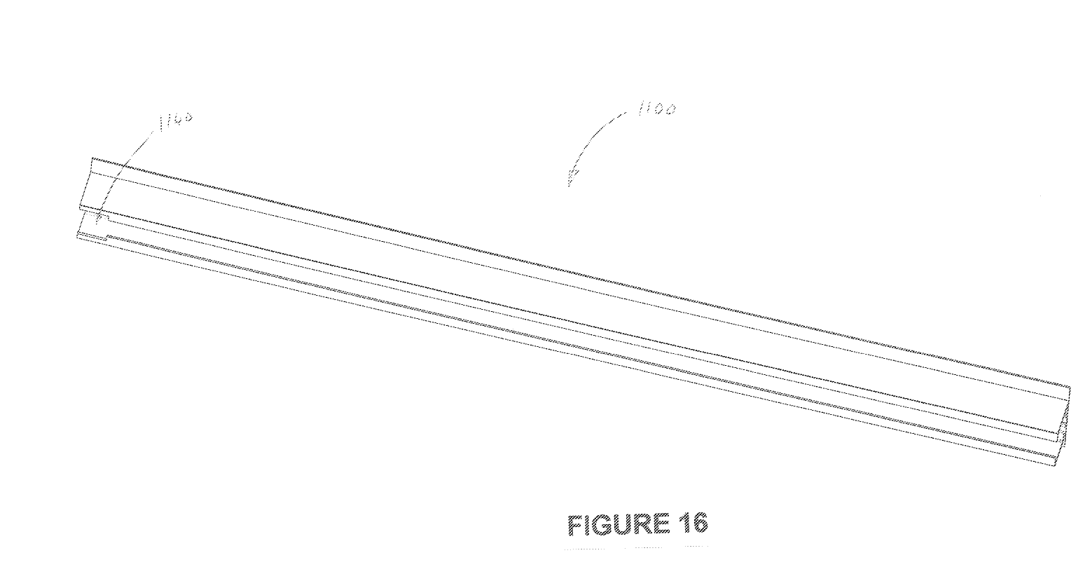

The cross sectional shape and configuration of the track arrangement 1110 is preferably substantially uniform along its length, except of course for at the widened portion 1140 as shown in FIGS. 15 and 16.

The widened portion 1140 constitutes a widening of the slot 1130 sufficiently for a running arrangement 1230 (i.e. one of the sets of wheel 1240 disposed at each opposed end of the body member 1220) to be removed from within the hollow member 1120.

Hence, in order to remove one of the running arrangements 1230 from within the hollow member 1120, the carriage 1200 is moved along the guide path 1110 until one of the sets of wheels 1240 disposed at each end of the body member 1220 is in alignment with the widened portion 1140. The set of wheels 1240 can then be dropped out from the hollow member 1120 via the widened portion 1140. As the running arrangement 1230 drops out from the widened portion 1140, the body member 1220, together with the damping mechanism 1300 are able to drop out of the hollow member 1120 through the slot 1130 by virtue of them having a smaller width than the slot width. The other set of wheels 1240 at the opposed end of the elongate body member 1220 can then be moved to the widened portion 1140, and dropped out of the widened portion 1140 as well.

In this way, the carriage 1200 can be removed from the track arrangement 1100 for maintenance, replacement and/or repair purposes.

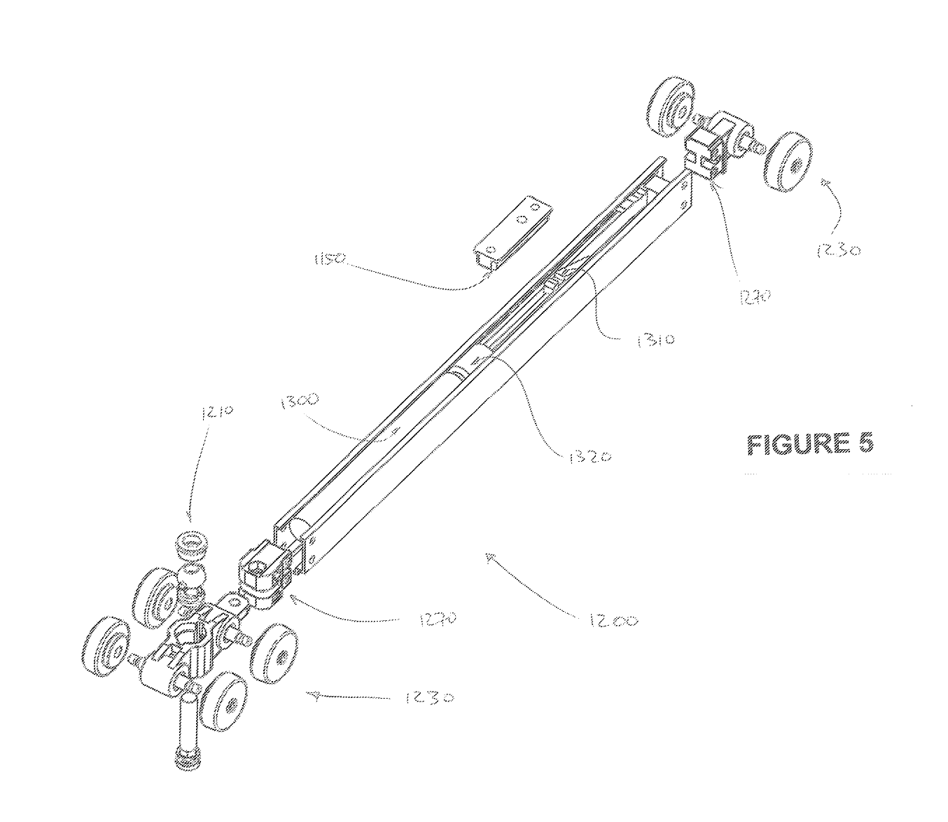

In this regard, it is envisaged that the running arrangements 1230 at either end of the body member will be removably connected to the body member 1220 by removable connecting formations 1270, such as a spigot and socket arrangement shown in FIG. 5, or be configured to be removably connected to the body member in a press-fit type arrangement. It will be appreciated that many variety of connections are possible in this regard. In this way, the running arrangement 1230 and body member 1220 may be conveniently decoupled from each other for replacement and repair.

In one embodiment envisaged, a single engaging formation on the body member can be configured to be engageable with a plurality of complementary engaging formations associated with the track arrangement, with each complementary engaging formation associated with its own piston and cylinder arrangement 1320.

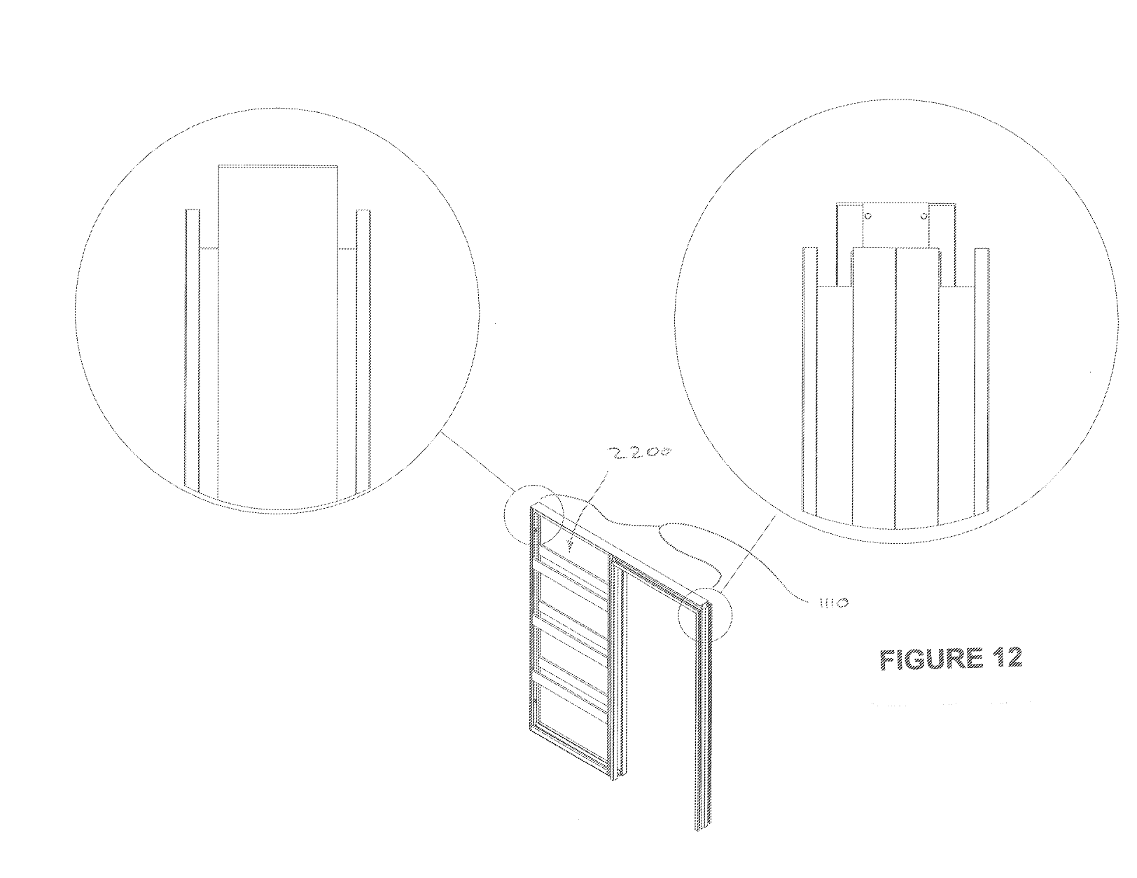

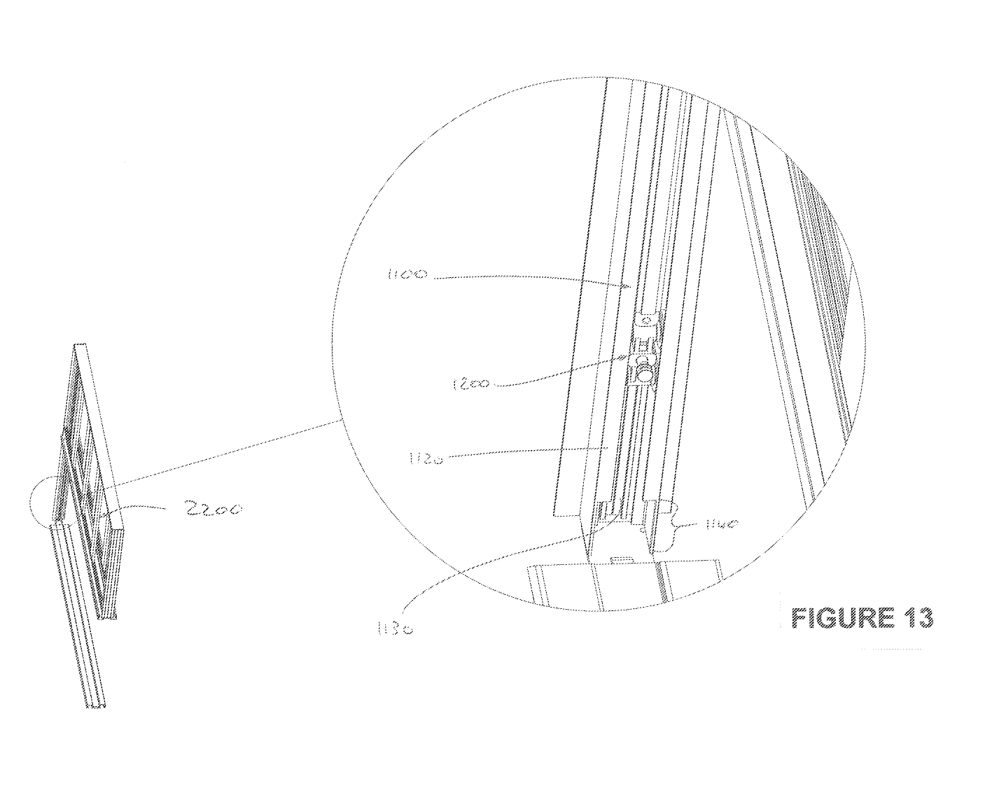

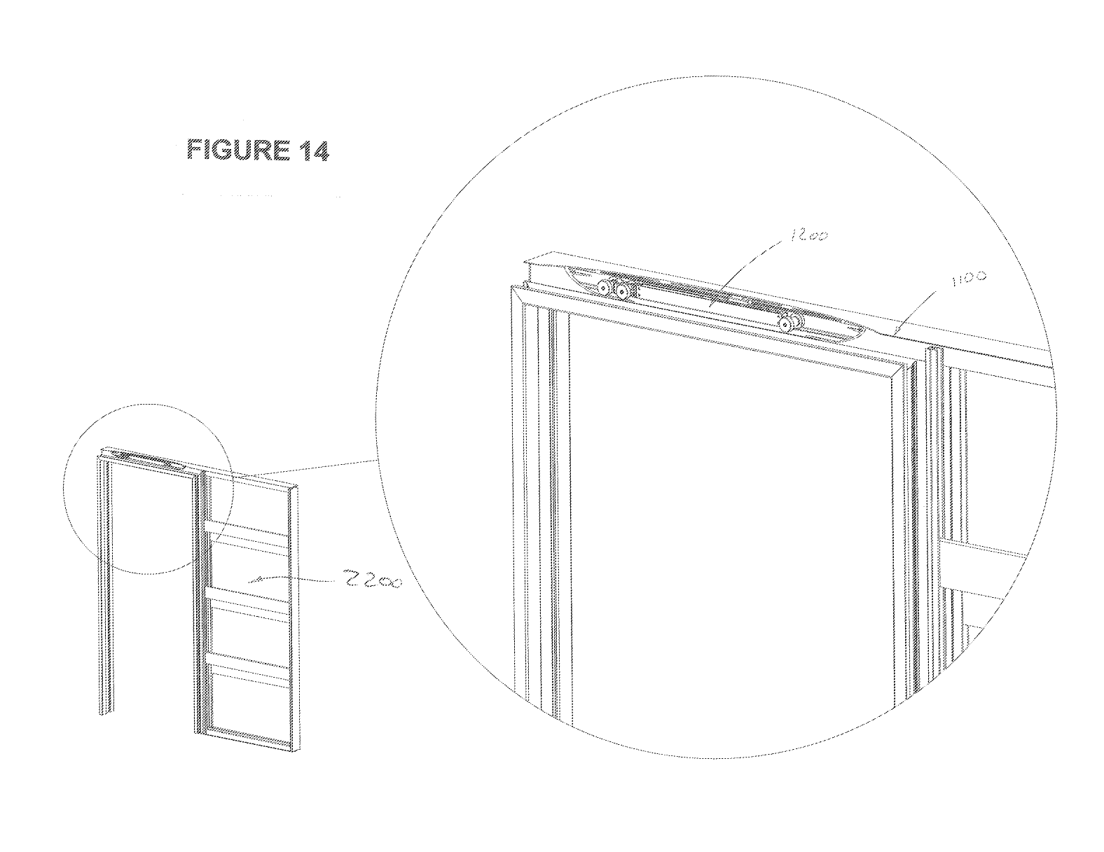

The above features as described will now be put into context of use of the sliding closure 2100. A damping assembly 1000 as described above is expected to be used for pocket-type sliding closures as shown in FIGS. 12-14.

In such a configuration, a sliding closure 2100 is movable into a recessed cavity 2200, for example in a wall 5000. The track arrangement 1100 is, in such configurations, also configured to extend into the recessed cavity at one end, and up to a transversely extending wall surface (for example) at its opposed end. Such a configuration would for example be used to close a passageway. The configuration of deployment of such a sliding closure does not allow for removal of the carriage longitudinally from an end of the hollow member 1120.

Further, it is envisaged that the track arrangement 1100 itself may be disposed in a recess in the ceiling (not shown). Such a configuration may be aesthetically desirable.

Such a configuration also would not allow for the removal of the carriage 1200 longitudinally from an end of the hollow member 1120. For this reason, the carriage 1200 must be removable from the track arrangement 1100 in a direction transverse to the guide path 1110, and preferably out the bottom.

In one embodiment, it is envisaged that the carriage may be removable from the guide path in a direction transversely and horizontally, while in another embodiment, it is envisaged that the carriage 1200 may be removable from the track arrangement in a direction transversely and vertically, depending on the configuration of the track arrangement with respect to the surrounding walls and recesses.

In one embodiment (not shown), it is envisaged that the complementary engaging formations 1150 located at or towards the end or ends of the guide path may be adjustable for position, in order to fine tune the closing and/or opening movement of the sliding closure under action of the damping mechanism 1300. It is envisaged that in such a configuration the complementary engaging formations will be adjustable for position by using a threaded formation (not shown) such as a nut and bolt formation.

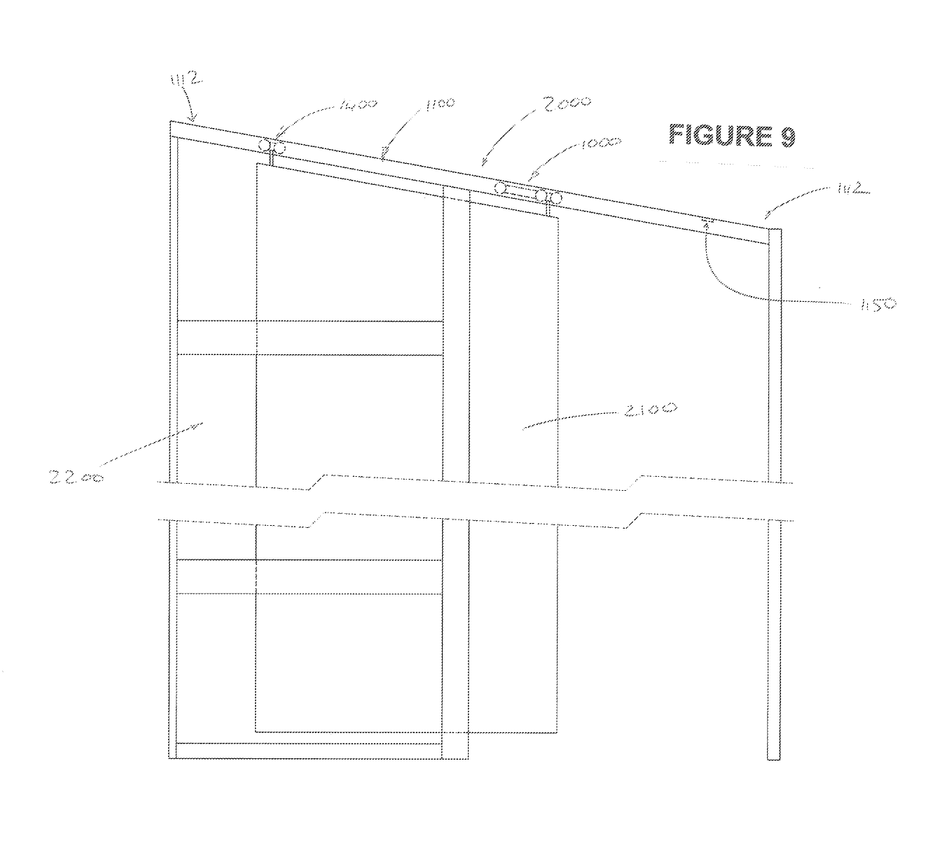

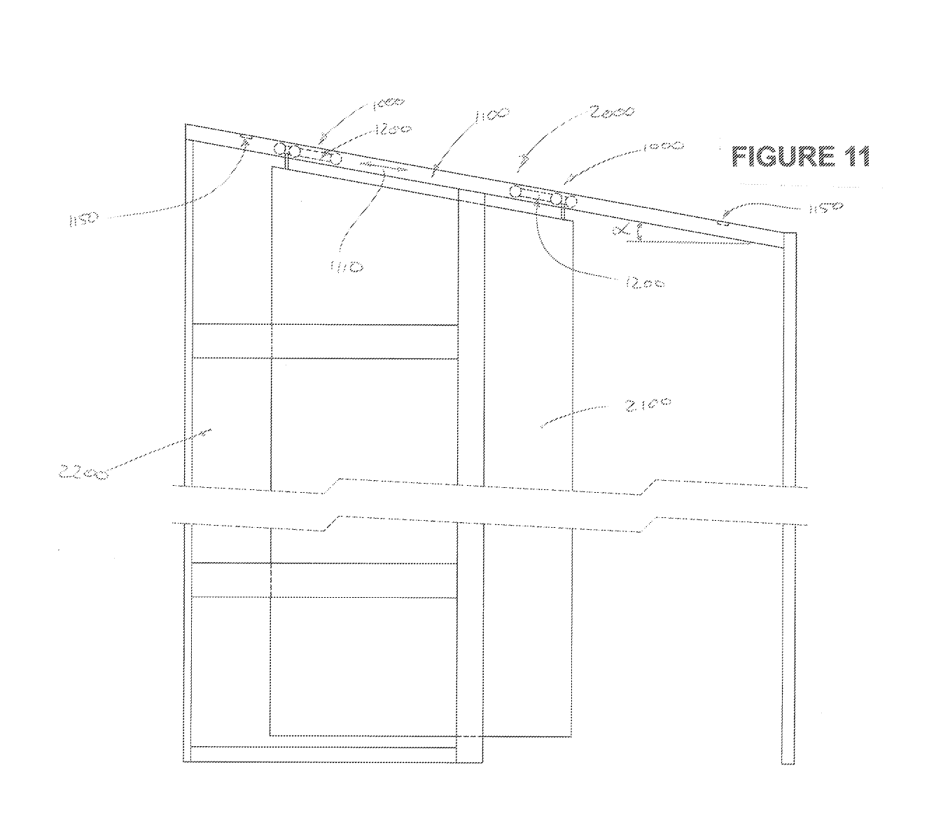

In another embodiment, the track arrangement 1100 will be disposed substantially horizontally, although this need not be the case. In an alternative embodiment, for example as shown in FIGS. 9-11, it is envisaged that the track arrangement 1100 can be disposed at a slight angle α so that the weight of the sliding closure 2100, damping mechanism 1300 and carriage 1200 together cause the sliding closure 2100 to move towards either its open position or its closed position. Such a configuration ensures that the sliding closure 2100 will return to one of its predetermined positions, depending on the angle of alignment α of the track arrangement 1100.

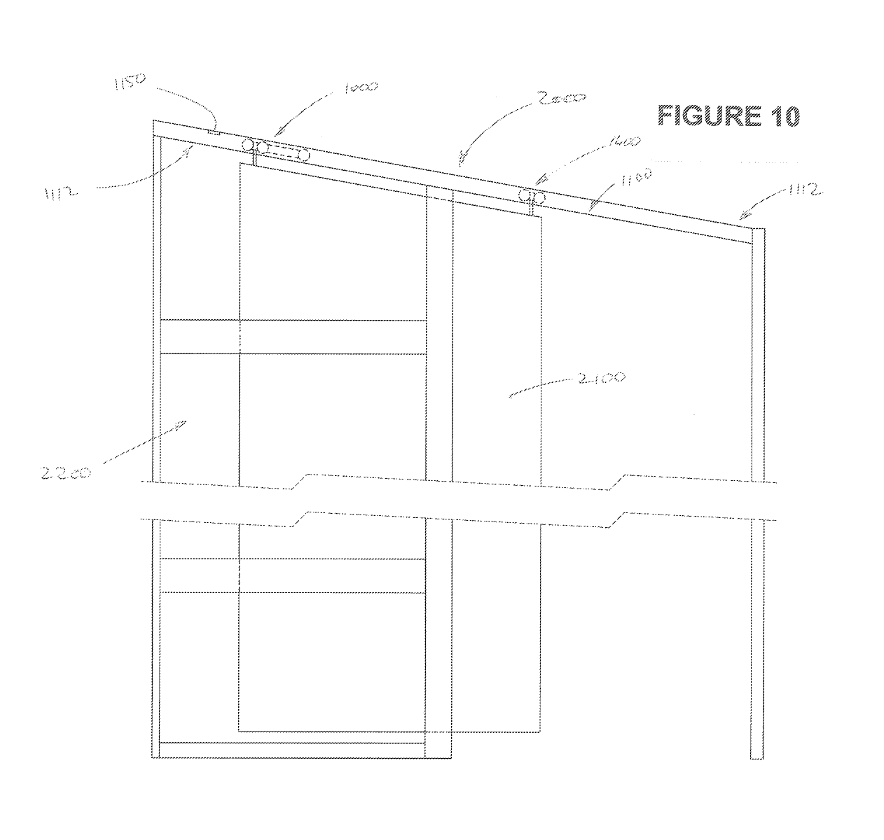

It will be noted in FIGS. 9-10 that, where a carriage 1200 with a damping mechanism 1300 in the form of a single acting piston and cylinder arrangement is provided at or towards only one end of the sliding closure to provide the damping action for either closing or opening, then an idler carriage 1400 may be provided to support the opposed end of the sliding closure 2100.

In another embodiment not shown, it is envisaged that a single piston and cylinder arrangement could be provided that has a double acting action, and which can be compressed from both sides. Such an arrangement could provide a damping of the movement of the sliding closure in both directions, without having to provide a single acting piston and cylinder arrangement at or towards opposed ends of the sliding closure.

Where the track arrangement is so aligned at a slight angle α, it is envisaged that the interaction of the engaging formation with the complementary engaging formation can have the further functionality of being able to hold the sliding closure open or closed against the force of gravity acting on the sliding closure 2100, damping mechanism 1300 and carriage 1200, to latch the sliding closure in that position.

Where the sliding closure 2100 is operated by a user to move it in a direction to move the bias to its compressed condition, and disengage the engaging formations 1310 from the complementary engaging formation 1150, this holding or latching effect will be removed, and the sliding closure 2100 will be able to move under action of gravity.

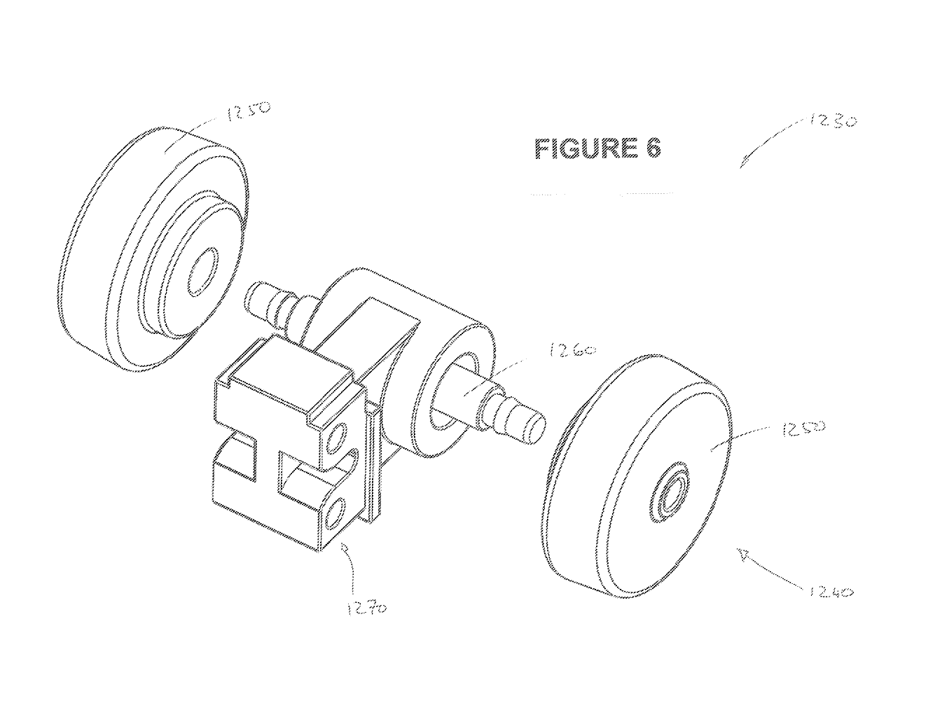

In order to facilitate the use of a damping mechanism in a configuration where the track arrangement is tilted at a slight angle, it is envisaged that the wheels of the carriage and/or the idler carriage 1400 will be mounted on bearings. In a preferred embodiment, a wheel or pair of wheels 1250 will be mounted on an axle 1260. As shown in FIG. 6 the axle 1260 extends transversely through the body member 1220 and have one or more wheels mounted to each end of the axle. The axle is in turn mounted on one or more needle roller bearings (not shown). By using needle roller bearings, the rolling resistance of each wheel 1250 or pair of wheels 1250 is reduced, allowing the sliding closure 2100 to move more freely under action of gravity

It will be appreciated that several alternative arrangements or mechanisms may be provided to provide a damping effect and or a biasing effect. As an example, compression of a compressible gas may be used instead of compression of a spring. Further, a wide variety of configurations of track arrangements are possible in addition to the embodiments shown.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

I claim:

1. A damping assembly, suitable for use with a sliding closure assembly, said damping assembly comprising:
a. a track arrangement configured and adapted for guiding movement of a carriage along a guide path;
b. a carriage moveable in a reciprocal manner along the guide path;
c. a damping mechanism for damping movement of said carriage as it approaches one or either end of the guide path;
d. wherein the carriage is removable from the track arrangement in a direction transverse to the direction of movement of the carriage on the track arrangement.

2. A damping assembly as claimed in claim 1, wherein the track arrangement is hollow.

3. A damping assembly as claimed in claim 1, wherein the track arrangement comprises a recess along its length along which the carriage is moveable.

4. A damping assembly as claimed in claim 3, wherein the recess is a slot.

5. A damping assembly as claimed in claim 2, wherein the track arrangement comprises a hollow member with a slot in a lower face.

6. A damping assembly as claimed in claim 1, wherein the damping assembly comprises a sliding closure.

7. A damping assembly as claimed in claim 1, wherein the carriage comprises support formations for supporting the sliding closure.

8. A damping assembly as claimed in claim 1, wherein the sliding closure is movable between an open position and a closed position on the carriage.

9. A damping assembly as claimed in claim 8, wherein the open position and a closed position corresponds to the sliding closure being in an open position and a closed position respectively.

10. A damping assembly as claimed in claim 1, wherein the carriage is configured for supporting the sliding closure through said slot.

11. A damping assembly as claimed in claim 1, wherein the damping mechanism is located on the carriage.

12. A damping assembly as claimed in claim 1, wherein the track arrangement comprises a widened portion.

13. A damping assembly as claimed in claim 1, wherein the carriage comprises a body member and an associated running arrangement.

14. A damping assembly as claimed in claim 13, wherein the damping mechanism is located on the body member.

15. A damping assembly as claimed in claim 13, wherein the body member and damping mechanism are together configured and adapted to be removed through the slot.

16. A damping assembly as claimed in claim 13, wherein the body member is elongate.

17. A damping assembly as claimed in claim 1, wherein the track arrangement is configured to extend into a recessed cavity operationally, the recessed cavity being configured for receiving the sliding closure.

18. A damping assembly as claimed in claim 16, wherein the width of the body member is thinner than the width of the slot.

19. A damping assembly as claimed in claim 1, wherein the running arrangements are removable from within the track arrangement via the widened portion.

20. A damping assembly as claimed in claim 13, wherein the running arrangements and body member are removably coupled to each other.

21. A damping assembly as claimed in claim 20, wherein the running arrangement and body member may be conveniently decoupled from each other.

22. A damping assembly as claimed in claim 13, wherein the running arrangement comprises one or more wheels.

23. A damping assembly as claimed in claim 22, wherein the running arrangement comprises one or more sets of wheels.

24. A damping assembly as claimed in claim 23, wherein the one or more sets of wheels are located at opposed ends of the carriage.

25. A damping assembly as claimed in claim 1, wherein the damping mechanism comprises an engaging formation on one or more of the carriage and the track arrangement, for engaging with complementary engaging formations located on the other of the carriage and the track arrangement.

26. A damping assembly as claimed in claim 24, wherein the damping mechanism comprises a piston reciprocally movable within a damping cylinder for damping movement of the carriage when the engaging formation encounters the complementary engaging formation, to thereby move the sliding door to one or more selected from its fully open position and fully closed position.

27. A damping assembly as claimed in claim 26, wherein the damping mechanism comprises damping fluid which is contained within the damping cylinder, which moves between a pair of enclosures through a damping valve when the piston moves within the cylinder.

28. A damping assembly as claimed in claim 1, wherein the damping mechanism is movable between a compressed condition and an uncompressed condition.

29. A damping assembly as claimed in claim 28, wherein the damping mechanism is biased towards one selected from its compressed condition and its uncompressed condition.

30. A damping assembly as claimed in claim 29, wherein the damping mechanism comprises a biasing arrangement that is movable between a compressed condition and an uncompressed condition.

31. A damping assembly as claimed in claim 30, wherein the compressed condition and an uncompressed condition of the biasing arrangement correlate with the compressed condition and an uncompressed condition of the damping mechanism.

32. A damping assembly as claimed in claim 30, wherein the biasing arrangement compresses one or more selected from a
a. spring; and
b. compressible fluid.

33. A damping assembly as claimed in claim 24, wherein a single engaging formation on the body member is engageable with a plurality of complementary engaging formations associated with the track arrangement.

34. A damping assembly as claimed in claim 1, wherein the track arrangement is disposed substantially horizontally.

35. A damping assembly as claimed in claim 1, wherein the track arrangement is disposed at an angle so that the weight of the sliding door and damping mechanism cause the sliding door to move towards one selected from the open position and the closed position.

36. A damping assembly as claimed in claim 24, wherein the engaging formation and complementary engaging formations engage with and hold each other as the carriage approaches an end of its guide path and the sliding closure moves to one selected from its open position and its closed position.

37. A damping assembly as claimed in claim 24, wherein the engaging formation and complementary engaging formations engage with and hold each other as the carriage approaches an end of its guide path, and actuates movement of the damping cylinder to move between its compressed condition and is uncompressed condition.

38. A damping assembly as claimed in claim 37, wherein the engaging formation and complementary engaging formations engage with and hold each other as the carriage approaches an end of its guide path, and actuates movement of the damping cylinder to move between its compressed condition and is uncompressed condition by virtue of its bias, thereby moving said sliding closure to said one or more selected from its open condition and its closed condition.

39. A damping assembly as claimed in claim 13, wherein the carriage comprises a running arrangement at opposed ends of the body member.

40. A damping assembly as claimed in claim 39, wherein either or both of the running arrangements are removably connectable to the body member by complementary connecting formations.

41. A damping assembly as claimed in claim 40, wherein the complementary connecting formations comprise a spigot and socket arrangement.

42. A damping assembly as claimed in claim 8, wherein the sliding closure when moving to its open position, moves into a recessed cavity.

43. A damping assembly as claimed in claim 42, wherein the recessed cavity is within a wall.

44. A damping assembly as claimed in claim 1, wherein the track arrangement is elongate and extends between two ends.

45. A damping assembly as claimed in claim 1, wherein the track arrangement is disposed within a recessed cavity.

46. A damping assembly as claimed in claim 44, wherein the engaging formation of the damping mechanism is engageable with complementary engaging formations disposed at or towards each end of the track arrangement.

47. A damping assembly as claimed in claim 7, wherein the support formations allow for convenient coupling of the sliding closure to the carriage.

48. A damping assembly as claimed in claim 1, wherein the coupling is by means of one or more selected from the following;
a. screw fitting, or
b. bayonet fitting, and
c. snap fitting.

49. A damping assembly as claimed in claim 24, wherein the complementary engaging formations for engagement with the engaging formation of the damping mechanism are adjustable for position.

50. A damping assembly as claimed in claim 49, wherein the complementary engaging formations for engagement with the engaging formation of the damping mechanism are adjustable for position by a threaded formation.

51. A damping assembly as claimed in claim 22, wherein each wheel is associated with an axle.

52. A damping assembly as claimed in claim 51, wherein a pair of wheels is associated with an axle.

53. A damping assembly as claimed in claim 52, wherein at least one axle is mounted on a set of bearings.

54. A damping assembly as claimed in claim 53, wherein at least one axle is mounted on a set of needle roller bearings.

55. A damping assembly as claimed in claim 54, wherein each axle is mounted on at least one or more needle roller bearings.

56. A damping assembly as claimed in claim 1, wherein the sliding closure is a sliding door.

57. A damping assembly as claimed in claim 1, wherein the damping assembly comprises an idler carriage for facilitating the support of the sliding closure.

58. A method of removing a carriage including a body disposed intermediate at least two running arrangements on which the body is moveable on a track arrangement, said carriage being movable on a guide path along a track arrangement, said carriage being suitable for supporting a sliding closure from a track arrangement through one selected from a slot and a recess, said slot or recess comprising a widened portion, the body being thinner than said slot or recess, said method comprising the steps of
a. aligning a first running arrangement with a widened portion of said slot;
b. moving the first running arrangement through the widened portion; and
c. moving the body through the slot.

59. A method as claimed in claim 58, wherein the method comprises the steps of
a. aligning the second running arrangement with the widened portion of the slot; and
b. moving said other running arrangement through the widened portion to remove the carriage from the track arrangement.

60. A method as claimed in claim 58, wherein the running arrangements are sets of wheels.

61. A method as claimed in claim 58, wherein the body comprises a damping mechanism configured for damping movement of said carriage as it traverses at least one end of the guide path.

62. A sliding closure assembly comprising a damping assembly as claimed in claim 1.

63. A sliding closure assembly comprising a sliding closure supported from a damping assembly as claimed in claim 1.

64. A carriage for use on a track arrangement comprising a hollow member with a slot in it, wherein the carriage is removable from said slot in a direction substantially transversely to the direction of movement of the carriage on the track arrangement.
